(19) United States
(12) Patent Application Publication
(10) Pub. No.: US 2011/0219781 A1
(43) Pub. Date: Sep. 15, 2011

(54) GAS TURBINE ENGINE WITH TIE SHAFT FOR AXIAL HIGH PRESSURE COMPRESSOR ROTOR

(76) Inventors: Daniel Benjamin, Simsbury, CT (US); Christopher St. Mary, Hebron, CT (US); Daniel R. Kapszukiewicz, Plainfield, CT (US); Brian C. Lund, Moodus, CT (US)

(21) Appl. No.: 12/720,720

(22) Filed: Mar. 10, 2010

(51) Int. Cl. F02C 7/20; F04D 29/00

(52) U.S. Cl. 60/796; 416/198 A

(57) ABSTRACT

A compressor section to be mounted in a gas turbine engine has a plurality of axial compressor rotors arranged from an upstream location toward a downstream location. A tie shaft applies an axial force at one end of the compressor section and biases the compressor rotors against a hub at the opposite end. The downstream compressor is an axial compressor rotor. A gas turbine engine incorporating this structure is also claimed.

### BACKGROUND OF THE INVENTION

This application relates to a gas turbine engine with an axial high pressure compressor, wherein a tie shaft holds the high pressure compressor section together.

Gas turbine engines are known, and typically include a compressor, which compresses air and delivers it downstream into a combustion section. The air is mixed with fuel in the combustion section and combusted. Products of this combustion pass downstream over turbine rotors, driving the turbine rotors to rotate.

Typically, the compressor section is provided with a plurality of stages or rotors. Traditionally, these rotors were bolted together and included bolt flanges, or other structure to receive the attachment bolts. Other applications have rotors welded together.

More recently, it has been proposed to eliminate all of the bolts or weld joints with a single coupling which applies a force through the compressor rotors by using a tie shaft. These proposals have utilized a high pressure compressor with a centrifugal stage as the most downstream compressor rotor, and it is this centrifugal rotor which imparts the force from the tie shaft to the stack of rotors upstream.

### SUMMARY OF THE INVENTION

A compressor section to be mounted in a gas turbine engine has a plurality of compressor rotors arranged from an upstream location toward a downstream location. The compressor rotors stack is bounded by one hub at the upstream end and another hub at the downstream end. A tie shaft is secured to one of the hubs and applies an axial force to the opposite hub that will hold together the rotors stack and provide sufficient friction to transmit torque. The compressor is an axial compressor rotor.

A gas turbine engine incorporating this structure is also claimed.

These and other features of the present invention can be best understood from the following specification and drawings, the following of which is a brief description.

### BRIEF DESCRIPTION OF THE DRAWINGS

FIG. 1 is a cross-sectional view through a gas turbine engine incorporating this invention.

FIG. 2 shows an alternative embodiment.

### DETAILED DESCRIPTION OF THE PREFERRED EMBODIMENT

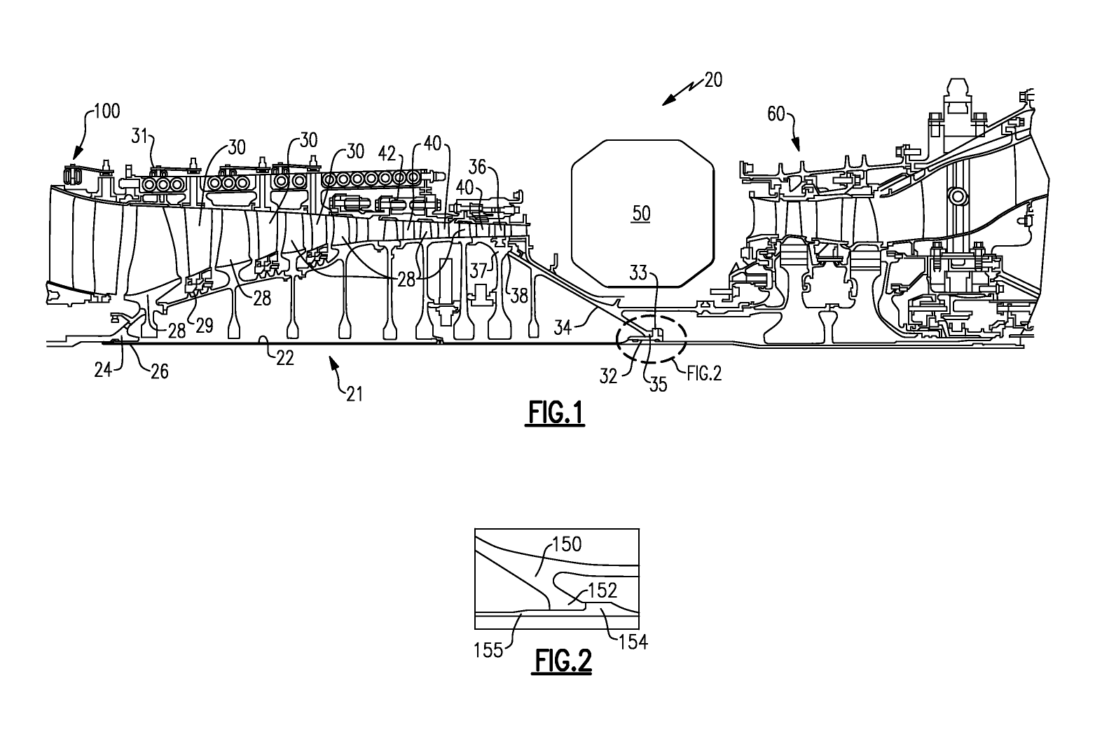

A portion of gas turbine engine 20 is illustrated in FIG. 1. A high pressure compressor section 21 includes an upstream hub 24 which is threadably connected at 26 to a tie shaft 22 for the gas turbine engine. A plurality of compressor rotors 28 are aligned axially from left to right in this view, and compress air and pass it downstream toward the combustion section 50. Spaced between the compressor rotors 28 are a plurality of vanes 30 and 40. The vanes 30 are variable position vanes, and include actuators or drive structure 31 at an outer periphery, a pivot mounts 29 at both an inner and an outer periphery.

More downstream fixed position vanes 40 are cantilever mounted, or unsupported at their inner periphery.

The compressor rotors 30 are clamped together between the upstream and downstream hubs, 24 and 34 respectively using the tie shaft 22 to apply the axial force. The axial force is applied to the downstream hub 34 by nut 32 that is threadably secured to the tie shaft 22; the force is transmitted from nut 22 to the downstream hub 34 through an end 35 abutting a ledge 33 on a nut 32. The upstream hub 34 applies a force at contact face 38 on the most downstream compressor rotor 37. This rotor 37 includes airfoils 36 positioned to be radially outwardly of contact face 38. In this manner, force is loaded onto the most downstream compressor rotor section 37, which in turn applies the force to hold all of the other compressor rotors against the upstream hub 24 and creates the friction necessary to transmit torque.

The axial force is set by mechanical stretch of tie shaft 22 prior to tightening of nut 32 so that the high friction on the interface between nut 32 and downstream hub 34 is eliminated; a similar stretching of tie shaft 22 is used prior to disassembly.

Notably, the nut 32 could also be positioned to be upstream of the tie shaft 22, and provide an appropriate tightening.

The single tie shaft precludes stresses associated with holes in the compressor rotors, high part count and weight associated with multiple sets of fasteners used at each rotor interface.

As can be appreciated from FIGS. 1, the downstream rotor 37 is an axial compressor.

While a single blade and a single vane is shown in the FIG. 1 for each of the stages, it should be appreciated that all of these stages surround a central drive axis for the tie shaft 22, and include a plurality of circumferentially spaced blades and vanes.

Further, as can be appreciated, a combustion section 50 is positioned downstream of the compressor section 21, and a low pressure compressor section 100 is positioned upstream of the high pressure compressor section 21. Products of combustion from the combustion section 50 pass downstream over a turbine section 60. The turbine section 60 includes rotors driven to rotate the compressor rotor. The downstream hub 34 provides the coupling between the compressor and turbine sections, in disclosed embodiments.

As also can be appreciated in FIG. 1, the portion of the tie shaft extends upstream, and holds the turbine rotors together also. This feature is better described in co-pending patent application serial number, entitled “Single Tie Rod Connection for Securing Compressor Section and Turbine Section,” filed on even date herewith.

Downstream hub 34 extends radially outwardly from radially inner end 35. The radially inner end abuts nut 32 secured to tie shaft 22, and said radially outer end abutting said downstream compressor rotor.

The nut or other securement member includes a ledge 33 extending radially outwardly to capture radially inner end 35. Ledge 33 applies force to downstream hub 34 when the nut is tightened on tie shaft 22.

In addition, as can be appreciated, the contact face 38 is radially inward of the blades 36. The use of the axial compressor as the most downstream compressor thus provides a smaller radial envelope for the compressor section.

FIG. 2 shows an alternative fixed (non-adjustable) mount between a tie shaft 22 and downstream hub 150. In this embodiment, the tie shaft 155 has a ledge portion 154 that that abuts against the downstream hub end 152. Tie shaft 155 is stretched prior to assembly to a preset axial displacement, then released to apply the axial force to the compressor stack.

Co-pending application serial number , entitled “Compressor Section with Tie Shaft Mount and Cantilever Mounted Vanes” and filed on even date herewith focuses on the use of the downstream cantilever mount vanes. The co-pending patent application serial number , entitled “Single Tie Rod Connection for Securing Compressor Section and Turbine Section” and filed on even date herewith focuses on the assembly of the compressor and rotor sections. In addition, co-pending application serial number , entitled “Gas Turbine Engine Rotor Sections Held Together by Tie Shaft, and With Blade Rim Undercut,” filed on even date herewith, focuses on structure for an integrally bladed rotor.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A compressor section to be mounted in a gas turbine engine comprising:
a plurality of axial compressor rotors arranged from an upstream rotor toward a downstream rotor;
upstream and downstream hubs at ends of the compressor rotor stack and join it to the shaft
a tie shaft to apply a force at the downstream hub of said compressor section to hold said plurality of axial compressor rotors together, and provide the friction necessary to transmit torque; and
said downstream rotor being an axial compressor rotor.

2. The compressor section as set forth in claim 1, wherein said downstream hub extends radially outwardly from a radially inner end, said radially inner end abutting a securement member to be secured to the tie shaft of a gas turbine engine, and a radially outer end abutting said downstream rotor.

3. The compressor section as set forth in claim 2, wherein said radially outer end including a contact face on said downstream rotor, said contact face being radially inward of a compressor blade in said downstream rotor such that air compressed by said downstream rotor passes radially outwardly of said downstream hub.

4. The compressor section as set forth in claim 3, wherein said securement member applies an axial force to said downstream hub.

5. The compressor section as set forth in claim 1, wherein said plurality of axial compressor rotors together form a high pressure compressor section.

6. A gas turbine engine comprising:
a compressor section;
a combustion section downstream of said compressor section;
a turbine section downstream of said combustion section, said turbine section including turbine rotors to drive and rotate compressor rotors associated with said compressor section; and
said compressor rotors include a plurality of compressor rotors arranged from an upstream rotor toward a downstream rotor, and a tie shaft to apply a force at said compressor rotor via a downstream hub, to clamp said compressor rotors against an upstream hub to provide friction to transmit torque, and said downstream compressor rotor being an axial compressor rotor.

7. The gas turbine engine as set forth in claim 6, wherein said downstream hub extends radially outwardly from a radial inner end, said radially inner end abutting a securement member, and said radially outer end abutting said downstream rotor.

8. The gas turbine engine as set forth in claim 7, wherein said radially outer end including a contact face at said downstream rotor, said contact face being radially inward of a compressor blade in said downstream compressor rotor such that air compressed by said downstream compressor rotor passes radially outwardly of said downstream tie shaft.

9. The gas turbine engine as set forth in claim 8, wherein said securement member is tightened on a tie shaft.

10. The gas turbine engine as set forth in claim 6, wherein said plurality of compressor rotors together form a high pressure compressor section and there is an upstream low pressure compressor upstream of said upstream tie shaft.
